(19) United States
(12) Patent Application Publication
(10) Pub. No.: US 2021/0312572 A1
(43) Pub. Date: Oct. 7, 2021

(54) METHOD OF RECORDING LURE FISHING DATA USING A SMART WATCH

(71) Applicant: Guangdong Coros Sports Technology Co., Ltd., Dongguan (CN)

(72) Inventors: Haotian Niu, Dongguan (CN); Lvyan Bi, Dongguan (CN); Yu Tang, Dongguan (CN)

(21) Appl. No.: 16/950,859

(22) Filed: Nov. 17, 2020

(30) Foreign Application Priority Data
Apr. 3, 2020 (CN) 202010263620.X

(51) Int. Cl. G06Q 50/02; G04B 47/06; A01K 97/00

(52) U.S. Cl. CPC G06Q 50/02; A01K 97/00; G04B 47/06

(57) ABSTRACT

A method of recording lure fishing data using a smart watch includes collecting a rotation angle variation of user's hand; if no variation is collected, determining that a current motion is a motion of stopping winding fishing line; if a variation is collected, judging the variation is caused by a motion of winding fishing line or a motion of stopping winding fishing line, matching the motion with a preset motion, recording one occurrence of retrieving fishing rod if the matching is successful. The method further includes collecting an acceleration value and an angular velocity value; calculating a displacement value and an angle variation value to form continuous coordinate points; fitting the coordinate points into a real-time trajectory; matching the real-time trajectory with a preset casting trajectory; and recording one occurrence of casting fishing rod once said matching is successful.

### RELATED APPLICATIONS

This application claims the benefit of priority to Chinese invention applications No. 202010263620.X filed on Apr. 3, 2020, which is hereby incorporated by reference in its entirety.

### FIELD OF THE INVENTION

The present invention relates to a field of lure fishing, in particular to a method of recording lure fishing data using a smart watch and a smart watch.

### BACKGROUND OF THE INVENTION

Lure fishing is a popular sport, which uses a lure product artificially made to simulate lifelike natural fish, shrimps, insects, etc. in the water to attract a target fish. Instead of quietly waiting for the fish to catch the lure, lure fishing requires the angler to control the fishing rod to apply different tugging forces and dragging forces to the lure in the water, making the lure to present some motions similar to swimming, running, struggling, and convulsing in the water, so as to attract the target fish. Compared with the traditional fishing method, the lure fishing method is environmentally friendly, pollution-free, and easy to carry, which is a very healthy and elegant exercise. However, there are currently very few wearable devices that can record lure fishing data, thus it's impossible for users to effectively analyze and improve their fishing technology, and it is also difficult to share the fishing data with other lure anglers.

### SUMMARY OF the INVENTION

Objectives of the present invention are to provide a method of recording lure fishing data using a smart watch, a smart watch and a readable storage media, which can record the lure fishing data.

To achieve the above objectives, the present invention provides a method of recording lure fishing data using a smart watch. The lure fishing data includes number of times a fishing rod is retrieved and/or cast.

When the lure fishing data denoting the number of times a fishing rod is retrieved, the method includes:

collecting a rotation angle variation of user's hand in real time:

if no rotation angle variation is collected, determining that a current motion is a motion of stopping winding fishing line:

if a rotation angle variation is collected, calculating a value of the rotation angle variation and comparing the value of the rotation angle variation with a preset angle value;

if the value of the rotation angle variation is larger than the preset angle value, determining that the rotation angle variation is caused by a motion of winding fishing line; if the value of the rotation angle variation is smaller than the preset angle value, determining that the rotation angle variation is caused by a motion of stopping winding fishing line;

matching a continuous motion including the motion of winding fishing line and the motion of stopping winding fishing line with a motion group of retrieving fishing rod that is stored in a preset motion warehouse; and

if said matching is successful, recording one occurrence of retrieving fishing rod.

When the lure fishing data denoting the number of times a fishing rod is cast, the method includes:

collecting an acceleration value and an angular velocity value of user's hand in real time;

calculating a displacement value and an angle variation value of each time point relative to a previous time point to form continuous coordinate points;

fitting the coordinate points into a real-time trajectory in time sequence;

matching the real-time trajectory with a preset casting trajectory; and

if said matching is successful, recording one occurrence of casting fishing rod.

Preferably, the method further includes presetting different motion groups of retrieving fishing rod according to artificial bait types and/or target fish species.

Preferably, before collecting a rotation angle variation of user's hand in real time, the method further includes:

setting different options for different motion groups of retrieving fishing rod:

receiving user's option selection information; and

entering a matching mode of the motion group of retrieving fishing rod corresponding to a selected option.

Alternatively, the motion group of retrieving fishing rod stored in the preset motion warehouse includes a pause motion after the fishing rod is cast and a motion group during winding the fishing line.

Preferably, the method further includes receiving information entered by the user, the information including current fish amount and/or occurrences of sundries hooking; and calculating and displaying a total amount of hooked fish and/or the number of times sundries are hooked.

Preferably, the method further includes recording a fishing location of the user in real time; binding the lure fishing data recorded with the fishing location of the user; and generating a fishing map or a fishing trajectory based on said binding.

Preferably, the lure fishing data further includes duration of each lure fishing; and the method further comprises: analyzing fishing behavior in combination with the duration of each lure fishing and the number of times a fishing rod is retrieved and/or cast in each lure fishing.

Preferably, the preset casting trajectory includes a preset forward casting trajectory and a preset side casting trajectory; and the method includes:

when the real-time trajectory is successfully matched with the preset forward casting trajectory, recording one occurrence of a forward casting of a fishing rod; and

when the real-time trajectory is successfully matched with the preset side casting trajectory, recording one occurrence of a side casting of a fishing rod.

Additionally, the present invention provides a smart watch, comprising:

one or more processors;

one or more memories; and

one or more programs, stored in said one or more memories and configured to be executed by said one or more processors, and said one or more programs adapted for executing the method of recording lure fishing data using a smart watch mentioned above.

Further, the present invention provides a computer-readable storage medium including a computer program for testing, and the computer program being executed by a processor to implement the method of recording lure fishing data using a smart watch mentioned above.

In the present invention, by collecting the rotation angle variation of the user's hand, the current motion can be judged, and a continuous motion or action is collected and matched with the preset data, thus one occurrence of retrieving fishing rod will be determined and counted if the matching is successful. In addition, when the lure fishing data recorded by the present invention is the number of times a fishing rod is cast, the acceleration value and angular velocity value of the user's hand can be collected in real time to obtain continuous coordinate points, which can then be fitted into a real-time trajectory. And then the real-time trajectory will be matched with a preset casting trajectory, if the matching is successful, it can be regarded as one occurrence of casting fishing rod. In such a way, the number of times a fishing rod is cast can be recorded in real time and accurately. Based on the present invention, the number of times a fishing rod is retrieved and/or cast can be recorded in real time, thus the user can analyze and improve his fishing technology according to the recorded data, and it is also convenient to share with other lure anglers.

### BRIEF DESCRIPTION OF THE DRAWINGS

The accompanying drawings facilitate an understanding of the various embodiments of this invention. In such drawings:

FIG. 1 is a flowchart of a method of recording lure fishing data using a smart watch according to an embodiment of the present invention;

FIG. 2 is another flowchart of a method of recording lure fishing data using a smart watch according to an embodiment of the present invention; and

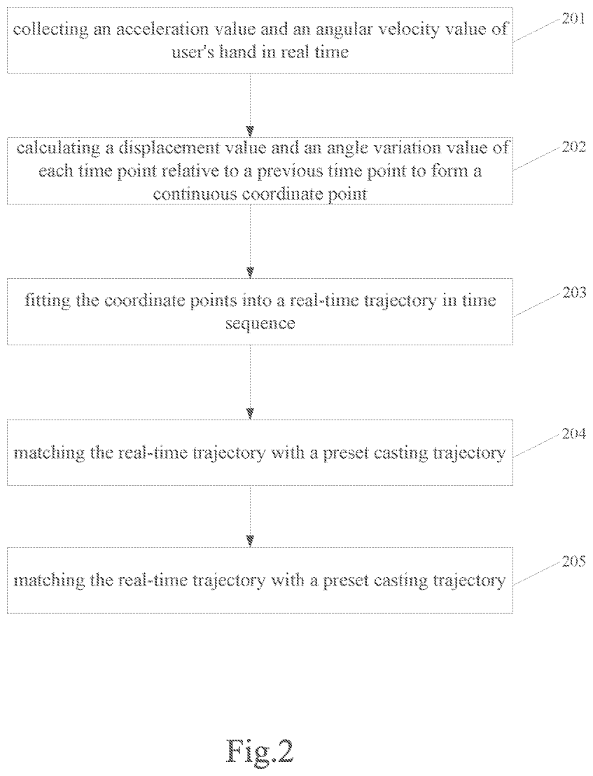

FIG. 3 is a schematic diagram of a smart watch according to an embodiment of the present invention.

### DETAILED DESCRIPTION OF ILLUSTRATED EMBODIMENTS

A distinct and full description of the technical solution of the present invention will follow by combining with the accompanying drawings.

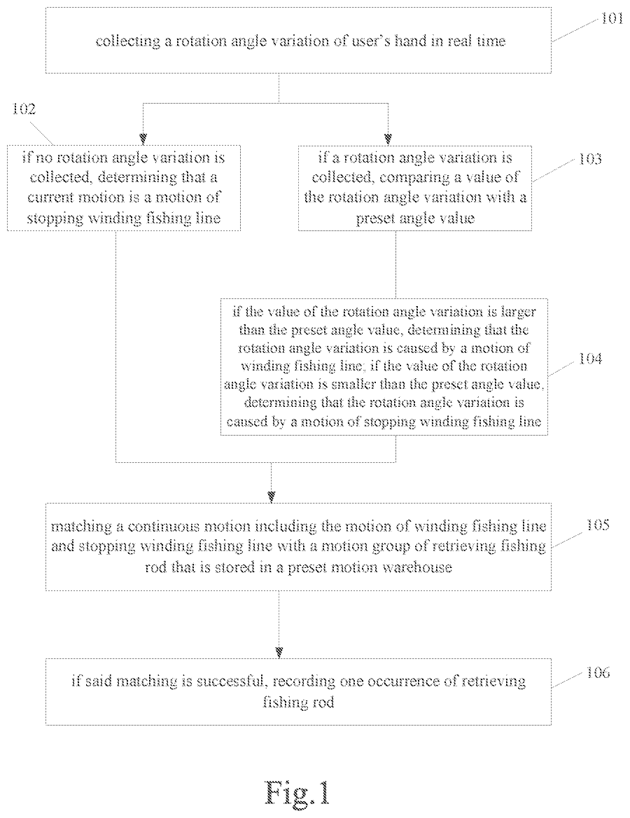

Referring to FIG. 1, the present invention provides a method of recording lure fishing data using a smart watch, and the lure fishing data including the number of times a fishing rod is retrieved and/or cast.

When the lure fishing data denotes denoting the number of times a fishing rod is retrieved, the method includes following steps:

Step 101, collecting a rotation angle variation of user's hand in real time.

Step 102, if no rotation angle variation is collected, determining that a current motion is a motion of stopping winding fishing line.

Step 103, if a rotation angle variation is collected, calculating a value of the rotation angle variation and comparing the value of the rotation angle variation with a preset angle value. In the disclosure, the rotation angle variation means the angle variation from the start of the rotation to the stop of the rotation.

Step 104, if the value of the rotation angle variation is larger than the preset angle value, determining that the rotation angle variation is caused by a motion of winding fishing line; if the value of the rotation angle variation is smaller than the preset angle value, determining that the rotation angle variation is caused by a motion of stopping winding fishing line. For example, the preset angle value is 60°. If the value of the rotation angle variation is greater than 60°, the current motion is determined as one occurrence of winding fishing line (winding motion); if the value of the rotation angle variation is less than 60°, the current motion is determined as one occurrence of stopping winding fishing line (winding pause motion). Of course, the preset angle value can be set according to the situation, and it is reasonable to set it between 30° to 360°. If the value of rotation angle variation is equal to the preset angle value, according to the preset setting, it can be classified as the winding motion or the winding pause motion.

Step 105, matching a continuous motion including the motion of winding fishing line and stopping winding fishing line with a motion group of retrieving fishing rod that is stored in a preset motion warehouse. Preferably, the preset motion warehouse can be set by the user, for example, multiple rotation angle variations generated by the user's hand/wrist when the fishing rod is retrieved are collected, accordingly, multiple motion groups of retrieving fishing rod are obtain, with the motion groups including motions of winding fishing line and stopping winding fishing line.

Step 106, if said matching is successful, recording one occurrence of retrieving fishing rod. It should be noted that “matching” has corresponding matching principle and matching score. When matching is performed according to the matching principle, if the matching score is greater than the preset score, the matching is deemed to be successful, otherwise unsuccessful.

When the lure fishing data denoting the number of times a fishing rod is cast, the method include the following steps:

Step 201, collecting an acceleration value and an angular velocity value of user's hand in real time.

Step 202, calculating a displacement value and an angle variation value of each time point relative to a previous time point to form a continuous coordinate point.

Step 203, fitting the coordinate points into a real-time trajectory in time sequence.

Step 204, matching the real-time trajectory with a preset casting trajectory.

Step 205, if said match is successful, recording one occurrence of casting fishing rod. For example, if the coincidence degree of the two trajectories is greater than or equal to 70%, the matching is considered to be successful, which is not limited here however and can be set.

In the process of retrieving the fishing rod, the motions actually include winding fishing line or stopping winding fishing line (for example jerking, jigging, tugging, pause, pop can be operated when the winding motion is stopped). When the target fish species or artificial bait types are the same, the continuous motions of winding fishing line and stopping winding fishing line during the line winding process conform to a certain change rule, so that it's viable to determine the occurrence of a motion of retrieving fishing rod by judging whether the motion conforms to the above-mentioned rule. In fact, while rotating the fishing reel, a rotate action at a certain sufficient angle will generated on user's hand; while the fishing line reeling is paused, no sufficient or no rotation angle will be generated. That's why it's viable to collect the rotation angle variation of user's hand to judge the current motion. Specifically, if the rotation angle variation is larger than a preset angle, determining that the rotation angle variation is caused by a motion of winding fishing line, if the rotation angle variation is smaller than the preset angle, or no rotation angle variation is generated, determining that the rotation angle variation is caused by a motion of stopping winding fishing line. In such a way, continuously collecting the motion of the user*' hand, and matching the motion with the preset motion group, and thus one occurrence of retrieving fishing rod will be determined and counted if the matching is successful.

In addition, when the lure fishing data recorded by the present invention is the number of times a fishing rod is cast, the acceleration value and angular velocity value of the user's hand can be collected in real time to obtain continuous coordinate points, which can then be fitted into a real-time trajectory. And then the real-time trajectory will be matched with a preset casting trajectory, if the matching is successful, it can be regarded as one occurrence of casting fishing rod. In such a way, the number of times a fishing rod is cast can be recorded in real time and accurately. Based on the present invention, the number of times a fishing rod is retrieved and/or cast can be recorded in real time, thus the user can analyze and improve his fishing technology according to the recorded data, and it is also convenient to share with other lure anglers.

Preferably, the smart watch of the present invention is worn on the wrist of the user performing the winding motion, so as to achieve a good collection of the rotation angle variation of the user's hand. Of course, the smart watch in the present invention is not limited to the traditionally recognized smart watch form that can only be worn on the wrist, any smart device that can be worn on or near the user's wrist and can achieve the purpose of the present invention should be included within the scope of coverage of the present invention.

In some embodiments, different motion groups of retrieving fishing rod can be set according to types of artificial baits and/or target fish species. For example, the target fish species can be blackfish, catfish, yellowtail, bass, carp, herring or silver carp; and the artificial bait can be popper, pencil, minnow, vibration, crank, worm, frog, or spinner, etc.

In some embodiments, before collecting a rotation angle variation of user's hand in real time, the method further includes:

setting different options for different motion groups of retrieving fishing rod;

receiving user's option selection information; and

entering a matching mode of the motion group of retrieving fishing rod corresponding to a selected option.

After receiving the user's option selection information, the system will enter the matching mode of the corresponding motion group of retrieving fishing rod. In such a way, the collected continuous motion will only be matched with the reel the corresponding motion group of winding, thus the matching is quick and accurate.

Alternatively, different options can be set according to the target fish species, or according to the types of artificial bait.

For example, the user can select different options in the watch according to the target fish species that he wants to lure to accurately match each motion group, if the matching is successful, the number of times a fishing rod is retrieved will be counted +1. More specifically, for example, options A-E are set to correspond to the motion groups of retrieving fishing rod I-V for different fish species. Before starting the lure fishing, the user first selects the option corresponding to the target fish species, if a matching performed is successful, then the number of times a fishing rod is retrieved will be counted +1. Of course, the options are not limited to the above embodiment, but can be various based on the target fish species arid the types of artificial bait preset in the smart watch. For example, different motion groups of retrieving fishing rod can be preset in the smart watch according to the target fish species such as blackfish, catfish, yellowtail, bass, carp, herring or silver carp, etc. Alternatively, options F-L are set to correspond to different motion groups of retrieving fishing rod VI-X for different artificial baits. Before starting the lure fishing, the user first selects the option corresponding to the artificial bait, if a matching performed is successful, then the number of times a fishing rod is retrieved will be counted +1. The artificial bait can be popper, pencil, minnow, vibration, crank, worm, frog, or spinner, etc.

In some embodiments, the motion groups of retrieving fishing rod in the preset motion warehouse includes the a pause motion after the fishing rod is cast and at least one motion group during winding the fishing line. In this case, the time at which a fishing rod casting motion is recognized each time can be regarded as the start time of a continuous action. Of course, the “continuous action” in the present invention is not limited. Once the current continuous action matches with one motion group in the preset motion warehouse, one occurrence of retrieving fishing rod is recorded. Note, the motion groups are not limited to above embodiment, which can be defined according to actual demands.

The following descriptions are examples showing different situations of retrieving the fishing rod.

Example 1

According to the target fish species or artificial bait types, the operations of winding fishing line include: casting the fishing rod, pause (namely stopping winding fishing line) for z1 seconds, winding fishing line, stopping winding fishing line for z2 seconds (while the fishing line is not reeled, several motions such as jerking, twitch, pause, pop may be operated), . . . until the fishing line is reeled completely, and then performing a next casting motion, wherein z1>z2. The motion group is preset in the smart watch, if the motions are matched successfully, the number of times the fishing rod is retrieved is counted by +1.

Example 2

According to the target fish species or artificial bait types, the operations of winding fishing line include: casting the fishing rod, pause (namely stopping winding fishing line) for z1 seconds, winding fishing line, stopping winding fishing line for z2 seconds (while the fishing line is not reeled, several motions such as jerking, twitch, pause, pop may be operated), . . . continuously winding fishing line (there is fish on the hook), and performing a next casting motion, wherein z1>z2. The motion group is preset in the smart watch, if the motions are matched successfully, the number of times the fishing rod is retrieved is counted by +1.

Example 3

According to the target fish species or artificial bait types, the operations of winding fishing line include: casting the fishing rod, pause (namely pause winding fishing line) for z1 seconds, winding fishing line, stopping winding fishing line for z2 seconds (while the fishing line is not reeled, several motions such as jerking, twitch, pause, pop may be operated), . . . continuously winding fishing line (there is fish on the hook), stopping winding fishing line, winding fishing line completely, and performing a next casting motion, wherein z1>z2. The motion group is preset in the smart watch, if the motions are matched successfully, the number of times the fishing rod is retrieved is counted by +1.

Example 4

According to the target fish species or artificial bait types, the operations of winding fishing line include: casting the fishing rod, pause (namely pause winding fishing line), continuously winding fishing line at a uniform speed, . . . until winding fishing line completely, and performing a next casting motion. The motion group is preset in the smart watch, if the motions are matched successfully, the number of times the fishing rod is retrieved is counted by +1.

Example 5

According to the target fish species or artificial bait types, the operations of winding fishing line include: casting the fishing rod, pause (namely pause winding fishing line), continuously winding fishing line at a uniform speed, . . . if a fish is hooked, accelerating the winding, stopping the winding, until winding completely, and performing a next casting motion, wherein the operations of stopping reeling and reeling, after a fish is hooked can be repeated for n times (n≥0). The motion group is preset in the smart watch, if the motions are matched successfully, the number of times the fishing rod is retrieved is counted by +1.

In some embodiments, the method of recording lure fishing data using a smart watch further includes:

receiving information entered by the user, the information including current fish number and/or sundries hooking; and

calculating and displaying a total number of caught fish and/or the number of times sundries are hooked; wherein said displaying is performed by a display module 24.

In such a way, the user can obtain the total number of caught fish and/or the number of times sundries are hooked in real time, and can analysis the fishing behavior accordingly.

Specifically, option “Fish +1” (the number of the hooked fish) can be displayed on the display module 24. When the user clicks on the display module 24 once, the number of the hooked fish is increased by 1. When the user clicks on the display module 24 N times, the number of the hooked fish is increased by N. Preferably, option “sundries hooked +1” (the occurrence sundries are hooked) also can be displayed on the display module 24, if the user clicks on the display module 24 once, the number of times sundries are hooked is increased by 1.

Alternatively, the user can also input the quantity information of the hooked fish or the occurrence sundries are hooked into the smart watch through a sound sensor (such as microphone, not shown).

In some embodiments, the lure fishing data also includes the duration of each lure fishing. The method further includes analyzing fishing behavior in combination with the duration of each lure fishing and the number of times a fishing rod is retrieved and/or cast in each lure fishing.

In some embodiments, the method of recording lure fishing data using a smart watch further includes:

recording a fishing location of the user in real time;

binding the lure fishing data recorded with the fishing location of the user; and

generating fishing map or fishing trajectory based on said binding.

In such a way, the user can clearly learn the fishing data of different fishing locations, which is beneficial to share with others.

Specifically, at least one of the lure fishing data can be displayed on the map according to corresponding latitude and longitude values, by which, the user can view the marked map that is generated with the lure fishing data, and can intuitively understand the fishing information.

The herein “lure fishing data” can be the number of times a fishing rod is retrieved and/or the number of times a fishing rod is cast, or other recordable data, such as fishing duration, and/or the number of hooked fish, etc.

In some embodiments, the preset casting trajectory includes a preset forward casting trajectory and a preset side casting trajectory. The method further includes:

when the real-time trajectory is successfully matched with the preset forward casting trajectory, recording one occurrence of a forward casting of a fishing rod; and

when the real-time trajectory is successfully matched with the preset side casting trajectory, recording one occurrence of a side casting of a fishing rod.

Since the forward casting trajectory and the side casting trajectory are obviously different, thus the number of times for different casting motions can be counted and recorded by comparing the current trajectory with a preset trajectory, which is for better reference.

Specifically, a displacement variation at time point N is calculated by the formula: Sₙ=Vₙₓ(Tₙ−Tₙ₋₁), Sₙ represents the displacement at time point N, Vn represents the speed at time point N, and Tₙ and Tₙ₋₁ represent time points N and time point N−1, respectively.

Specifically, Vₙ=Gₙₓ(Tₙ−Tₙ₋₁). Gₙ represents the acceleration value at the time point N.

The displacement variation in each direction of X, Y, Z is calculated in the same way. The displacement variation in each direction of X, Y, Z corresponds to the acceleration value and the calculated speed value in each direction X, Y, Z respectively.

When the angular velocity Ω is obtained, the angle variation at each time point can be calculated:

αn=Ωx(Tₙ−Tₙ₋₁).

The angle variation in each direction of X, Y, Z is calculated in the same way, and the angle variation in each direction of X, Y, Z corresponds to the angular velocity value in each direction of X, Y, Z respectively.

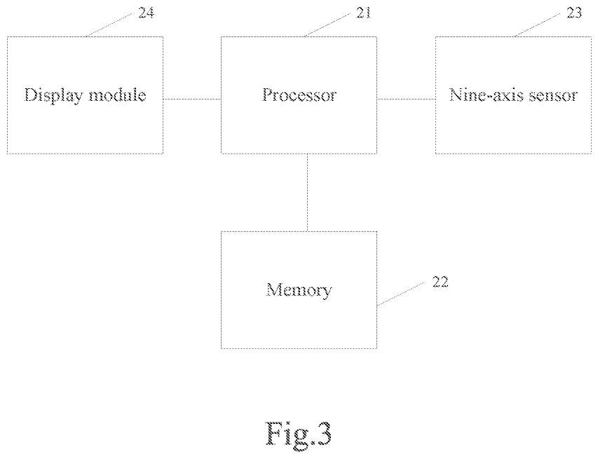

With reference to FIGS. 1 and 3, the present invention discloses a smart watch, including.

one or more processors 21;

one or more memories 22; and

one or more programs, stored in said one or more memories 22 and configured to be executed by said one or more processors 21, for executing the method of recording lure fishing data using a smart watch mentioned above.

In a specific embodiment, the smart watch includes a nine-axis sensor 23 composed of a combination of a three-axis gyroscope, a three-axis accelerometer, and a three-axis geomagnetometer. Specifically, the accelerometer is configured to sense the linear movement displacement in the X, Y, Z directions thereby collecting an acceleration value, and the gyroscope is configured to sense the direction of movement in the X, Y, Z directions thereby collecting the angular velocity value, so that the nine-axis sensor 23 can collect the acceleration value and angular velocity value in the X, Y, Z directions at a time frequency.

In a specific embodiment of the present invention, the smart watch includes a display module 24 to display related fishing information and the like.

The smart watch of the present invention can be worn on the left or right hand/wrist of the user, which is dependent on the user's operating habits. Preferably, the smart watch of the present invention is worn on the wrist of the user performing the winding motion, so as to achieve a good collection of the rotation angle variation of the user's hand. Of course, the smart watch in the present invention is not limited to the traditionally smart watch form that can only be worn on the wrist. Any smart device that can be worn on or near the user's hand/wrist and can achieve the purpose of the present invention should be included within the coverage scope of the present invention.

The present invention also discloses a readable storage medium in which programs are stored. When the programs are executed by the processor 21, to implement the method of recording lure fishing data using a smart watch as described above.

While the invention has been described in connection with what are presently considered to be the most practical and preferred embodiments, it is to be understood that the invention is not to be limited to the disclosed embodiments, but on the contrary, is intended to cover various modifications and equivalent arrangement included within the spirit and scope of the invention.

What is claimed is:

1. A method of recording lure fishing data using a smart watch, the lure fishing data including number of times a fishing rod is retrieved and/or cast:
when the lure fishing data denoting the number of times a fishing rod is retrieved, the method comprising:
collecting a rotation angle variation of user's hand in real time:
if no rotation angle variation is collected, determining that a current motion is a motion of stopping winding fishing line,
if a rotation angle variation is collected, calculating a value of the rotation angle variation and comparing the value of the rotation angle variation with a preset angle value;
if the value of the rotation angle variation is larger than the preset angle value, determining that the rotation angle variation is caused by a motion of winding fishing line; if the value of the rotation angle variation is smaller than the preset angle value, determining that the rotation angle variation is caused by a motion of stopping winding fishing line;
matching a continuous motion including the motion of winding fishing line and the motion of stopping winding fishing line with a motion group of retrieving fishing rod that is stored in a preset motion warehouse; and
if said matching is successful, recording one occurrence of retrieving fishing rod;
when the lure fishing data denoting the number of times a fishing rod is cast, the method comprising:
collecting an acceleration value and an angular velocity value of user's hand in real time;
calculating a displacement value and an angle variation value of each time point relative to a previous time point to form continuous coordinate points;
fitting the coordinate points into a real-time trajectory in time sequence;
matching the real-time trajectory with a preset casting trajectory; and
if said matching is successful, recording one occurrence of casting fishing rod.

2. The method of recording lure fishing data using a smart watch as claimed in claim 1, further comprising presetting different motion groups of retrieving fishing rod according to artificial bait types and/or target fish species.

3. The method of recording lure fishing data using a smart watch as claimed in claim 1, before collecting a rotation angle variation of user's hand in real time, further comprising:
setting different options for different motion groups of retrieving fishing rod;
receiving user's option selection information; and
entering a matching mode of the motion group of retrieving fishing rod corresponding to a selected option.

4. The method of recording lure fishing data using a smart watch as claimed in claim 1, wherein the motion group of retrieving fishing rod stored in the preset motion warehouse includes a pause motion after the fishing rod is cast and a motion group during winding the fishing line.

5. The method of recording lure fishing data using a smart watch as claimed in claim 1, further comprising:
receiving information entered by the user, the information including current fish amount and/or occurrences of sundries hooking; and
calculating and displaying a total amount of hooked fish and/or the number of times sundries are hooked.

6. The method of recording lure fishing data using a smart watch as claimed in claim 1, further comprising
recording a fishing location of the user in real time;
binding the lure fishing data recorded with the fishing location of the user; and
generating a fishing map or a fishing trajectory based on said binding.

7. The method of recording lure fishing data using a smart watch as claimed in claim 1, wherein the lure fishing data further includes duration of each lure fishing; and the method further comprises: analyzing fishing behavior in combination with the duration of each lure fishing and the number of times a fishing rod is retrieved and/or cast in each lure fishing.

8. The method of recording lure fishing data using a smart watch as claimed in claim 1, wherein the preset casting trajectory includes a preset forward casting trajectory and a preset side casting trajectory; and the method comprises:
when the real-time trajectory is successfully matched with the preset forward casting trajectory, recording one occurrence of a forward casting of a fishing rod; and
when the real-time trajectory is successfully matched with the preset side casting trajectory, recording one occurrence of a side casting of a fishing rod.

9. A smart watch, comprising:
one or more processors;
one or more memories; and
one or more programs, stored in said one or more memories and configured to be executed by said one or more processors, and said one or more programs adapted for executing the method of recording lure fishing data using a smart watch as claimed in claim 1.

10. A computer-readable storage medium, including one or more programs being executed by a processor to implement the method of recording lure fishing data using a smart watch as claimed in claim 1.
